(19) United States
(12) Patent Application Publication
(10) Pub. No.: US 2006/0006301 A1
(43) Pub. Date: Jan. 12, 2006

(54) Re-positionable advertising hanger and system

(76) Inventors: Anthony M. Turi, Maplewood, NJ (US); Jerome Glasser, Maplewood, NJ (US)

Correspondence Address: JEROME GLASSER, 16 SUNSET TERRACE, MAPLEWOOD, NJ, 07040, US

(21) Appl. No.: 10/889,295

(22) Filed: Jul. 12, 2004

(51) Int. Cl. B42F 1/00

(52) U.S. Cl. 248/304

(57) ABSTRACT

Inexpensively manufactured, re-positionable hanger-hook-like device which may also display a promotional advertising message while simultaneously functioning as a hanger is particularly useful for hanging garments and pocketbooks in public establishments. The device of this invention may also be impregnated with a scent to impart a fragrance to its general vicinity.

### FIELD OF THE INVENTION

The present invention relates to promotional advertising devices, and more particularly, to devices such as hooks or hangers which may be repositionable and on which items such as coats, jackets and pocketbooks may be hung.

### BACKGROUND OF THE INVENTION

Prior art discloses numerous devices which may be used for storing items in a hanging fashion when such an action is desirable. While many of these prior art innovations may be or may have been useful with regard to the particular function they perform, none is applicable for use in a crowded, public location where space is limited.

In a conventional, bar, for instance, there is rarely any provision made for patrons to store and/or protect items such as coats and pocketbooks. There is even the tendency for patrons' personal items to be haphazardly strewn, often by patrons themselves, onto an unorderly and unmanageable pile, often in an unmonitored corner of the establishment. This condition is usually harmful to personal items, which, in this manner, are frequently wrinkled, stained, ripped, stolen or otherwise damaged. In the instance that a form of coat check room does exist, many people are reluctant to avail themselves of the offered coat check services for two primary reasons: 1) the additional cost for the services, and 2) the inconvenience of potentially having to wait on a long line in order to retrieve any checked item(s). Thus, even when offered, these services are often considered disadvantageous since utilizing such services frequently impedes a patron's ability to leave, if so desired, on a moment's notice.

Consequently, most people who have coats or pocketbooks in a bar place these items on the barstool on which they sit. This, however, provides a negative experience for the patron, since the seat becomes uncomfortable. Furthermore, this condition is disastrous for the garment, pocketbook or carrying bag since, once placed on barstools, these items tend to fall to the dirty floor, after which they are often trampled upon by the dirty shoes of the throng of nearby patrons. Certainly, this circumstance is not conducive to maintaining personal items in attractive condition.

Some bars in the past have fixedly attached hooks to the exterior, patron-facing side of the bar which comes in contact with patrons legs. These hooks are virtually exclusively placed at approximately knee level and, therefore, are effectively useless with regard to protecting coats which are typically so long that they still make contact with and spread out over the floor area. The main reason these hooks are placed so low on the exterior of the bar is that there is the need on behalf of the bar owner to protect the bar or countertop itself, so that it is not scratched or otherwise damaged. Heretofore, no adequate means has been disclosed which affords protection for the garments and other personal items of patrons in a public house or restaurant. Moreover, no means has been heretofore disclosed which, further, offers a re-positionable hook or hanger that can protect a bar countertop or cocktail table and also be re-positioned to accommodate an increased number of additionally hung coats and/or pocketbooks.

In public establishments, there is also the practice to promote food and beverage brands through advertising. This practice is most common with napkins, matchbooks, and coasters. The need to display a brand name(s) offered by an establishment is an important one, since it serves to disclose to patrons some of the selection(s) available to them without imposing on the valuable time and effort of a bartender who would otherwise need to divert serving time to educate patrons regarding the selection available for consumption. Promotional advertising is also an important factor in a brand's effort to entice a prospective or current patron of a brand to purchase a showcased product.

Moreover, recent technological advances in the plastics industry now permit the production of molded and extruded products with a scent or fragrance integrally molded either throughout a coating, or plastic. By imparting a fragrance to the hanger-holder, smells which include but are not limited to smoke, sweat, and alcohols may be masked, thereby enhancing the pleasurable experience of patrons in public establishments.

### SUMMARY AND OBJECTS OF THE INVENTION

The present invention discloses a system which serves a first useful purpose by providing an inexpensive, safe, clean area to hang one's personal possessions and/or garments, particularly in a highly populated public establishment such as a bar.

Another object of this invention is to provide means to re-position the hanger-holder device which may be moved to accommodate an increased number of items hung on the bar, and yet still protect the bar countertop from scratching or other damage.

Yet another object of this invention is to provide an advertising medium to influence a person's buying habits, and which can, if so desired, be kept by the patron as a souvenir.

Yet still another object of this invention is to provide an inexpensive hanger-holder which is manufactured of a plastic strong-enough to support the weight of a traditional coat and/or pocketbook or briefcase, and which has a scent either mixed integrally throughout the plastic body, or coated over the plastic body which can contribute towards masking any offensive odors in the general area of its placement.

Another, still further object of this invention provides a storage packaging means including a vapor-barrier plastic known to one skilled in the art, in order to better maintain the scent of the hanger-holder within the packaging until use is desired.

Still another, yet further object of this invention is a hanger holder which can accommodate the attachment to it of items such as matchbooks and/or cigarettes, as well as any holder(s) for advertising postcards or business cards, so that patrons may easily access these items.

Yet still another, further object of this invention is a hanger-holder having an illumination element which may be battery operated and which may illuminate a promotional advertising area on the hanger-holder itself, or one on a bar or table top.

Another yet still further object of this invention is a hanger-holder having an illumination element which may be battery operated and which may, further, have a lens and image for projection onto a bar or table top or a ceiling to promote a message to patrons.

### BRIEF DESCRIPTION OF THE DRAWINGS

FIG. 1 discloses a frontal view of a hangar-hook with a perpendicular message-mount;

FIG. 2 discloses a side view of FIG. 1;

FIG. 3 discloses a frontal view of a hangar-hook with a parallel message-mount;

FIG. 4 discloses a side view of FIG. 3;

FIG. 5 discloses a side view of a hangar-hook with a parallel message-mount;

FIG. 6 discloses a side view of an angulated message-mount when in an unused position;

FIG. 7 discloses a side view of an angulated message-mount in a used position;

FIG. 8 discloses a side view of an angulated message-mount on a double-hook, when in an unused position;

FIG. 9 discloses a side view of a holder of an item such as a matchbook;

FIG. 10 discloses a frontal view of FIG. 9;

FIG. 11 discloses a frontal view of a traditional matchbook;

FIG. 12 discloses a conventional-type bar, having hooks hanging from it;

FIG. 13 discloses a side view of a matchbook as attached to an embodiment having an adhesive and adhesive-protective cover sheet;

FIG. 14 discloses the attaching process of a matchbook (or other item) to a message-mount;

FIG. 15 discloses a side view of the removal of an adhesive-protective cover sheet;

FIG. 16 discloses a side view of FIG. 15 featuring promotional advertising beneath clear adhesive;

FIG. 17 discloses a matchbook attached to a message-mount;

FIG. 18 discloses a side view of a hook embodiment;

FIG. 19 discloses a side view of an embodiment including a power source, a light source, and an on/off switch;

FIG. 20 discloses a side view of FIG. 19 and a power source;

FIG. 21 discloses a side view of FIG. 20 and a holder for an item such as a matchbook;

FIG. 22 discloses a side view of an embodiment having a power source and light source means, a lens and an image between said light source means and said lens;

FIG. 23 discloses a perspective view of an embodiment which can be attached to a rimless table;

FIG. 24 discloses a frontal view of hook having a broad advertising message and multiple areas for holding items such as matchbooks;

FIG. 25 discloses an anterior view of FIG. 24;

FIG. 26 discloses a frontal view of FIG. 24 with only one holder area;

FIG. 27 discloses a frontal view of FIG. 24 with a space for holding a cigarette-type pack;

FIG. 28 discloses a side view of FIG. 25 having a spring-loaded, pivotally attached second bracing element;

FIG. 29 discloses a perspective view of a hook having a holder for items such as postcards, cd's or cigarettes;

FIG. 30 discloses a frontal view of a multiple item holder also having a vertical staff to which items such as cigarette packs may be attached;

FIG. 31 discloses a vapor barrier bag for maintaining a scent within until use is desired.

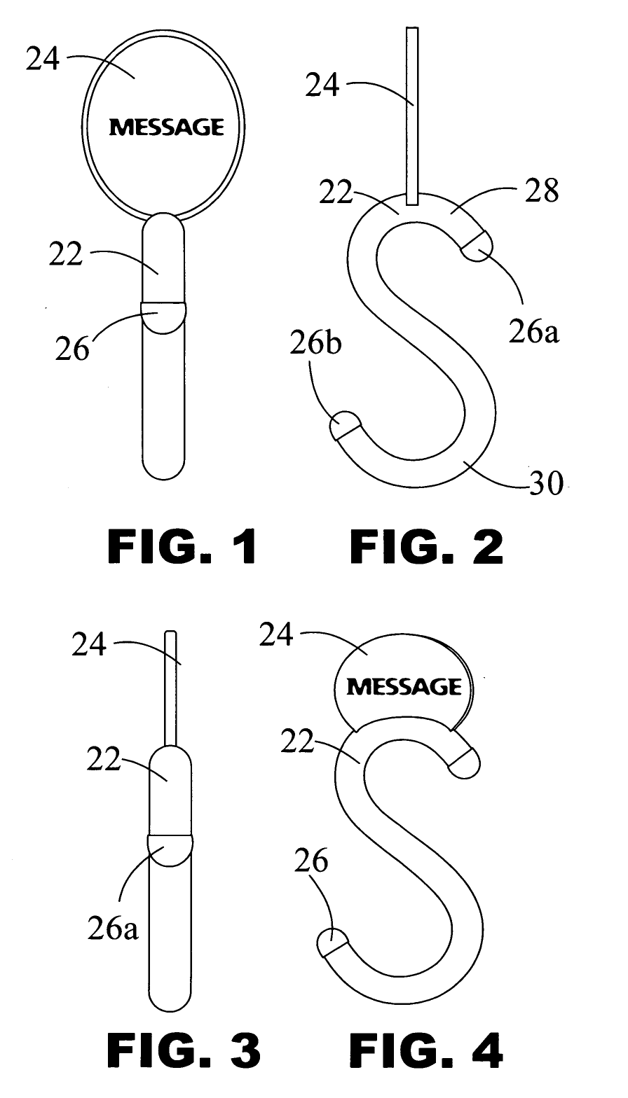

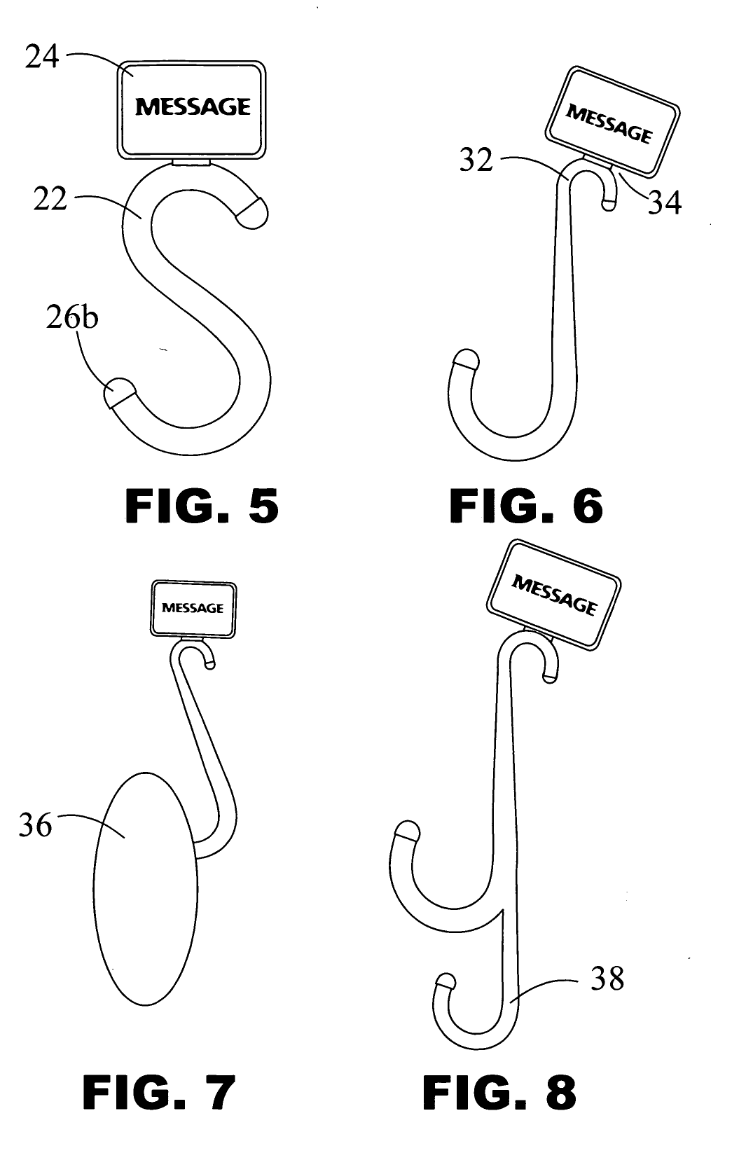

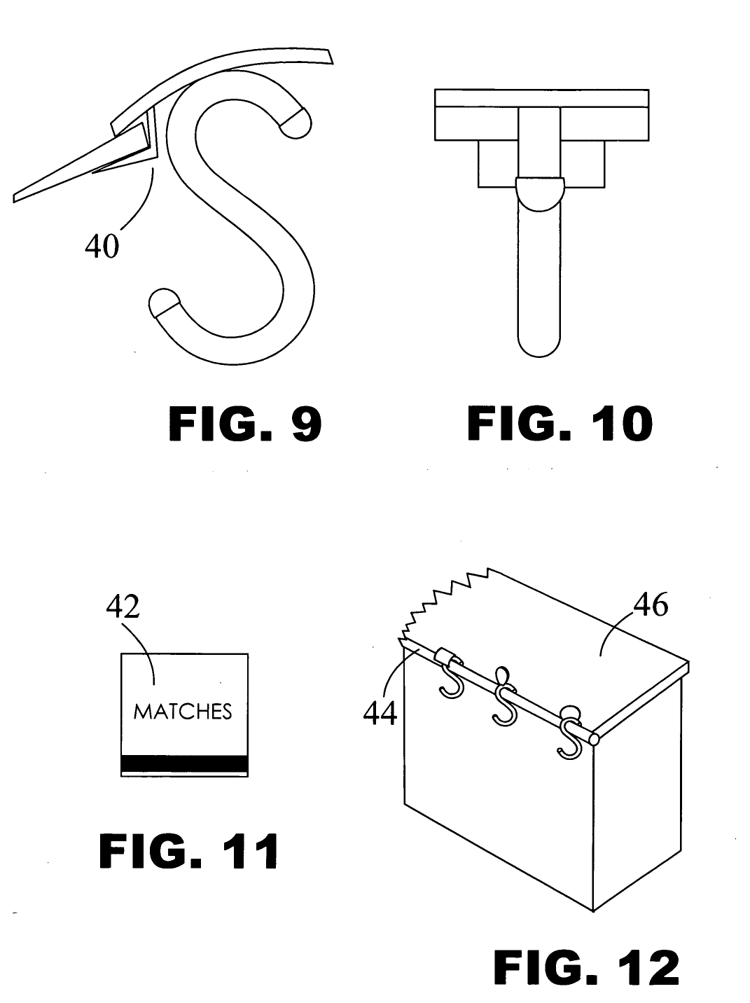

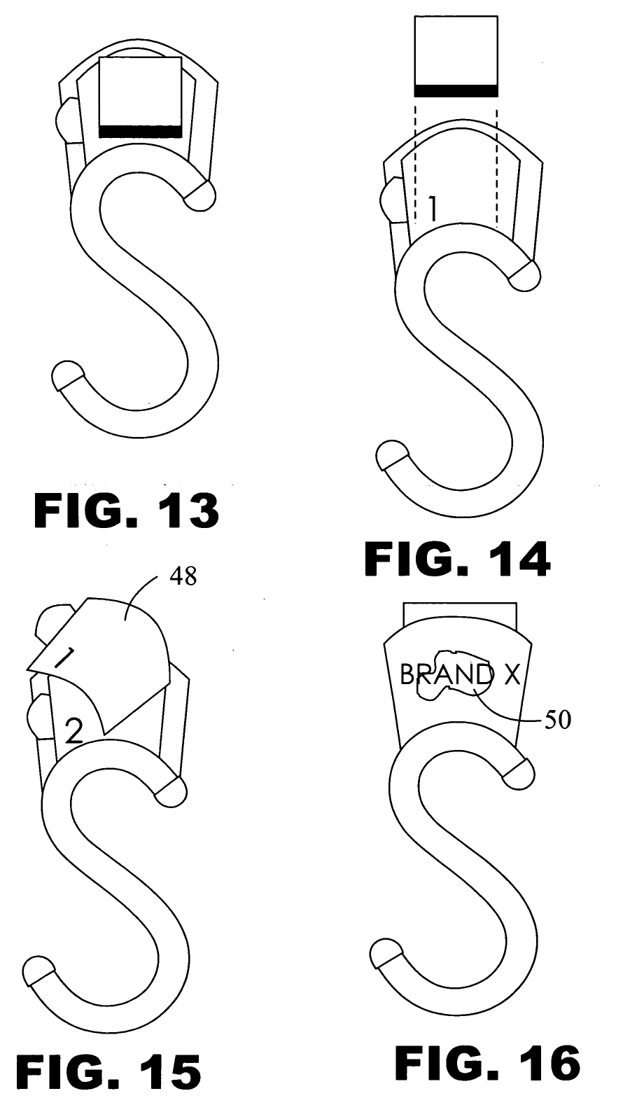

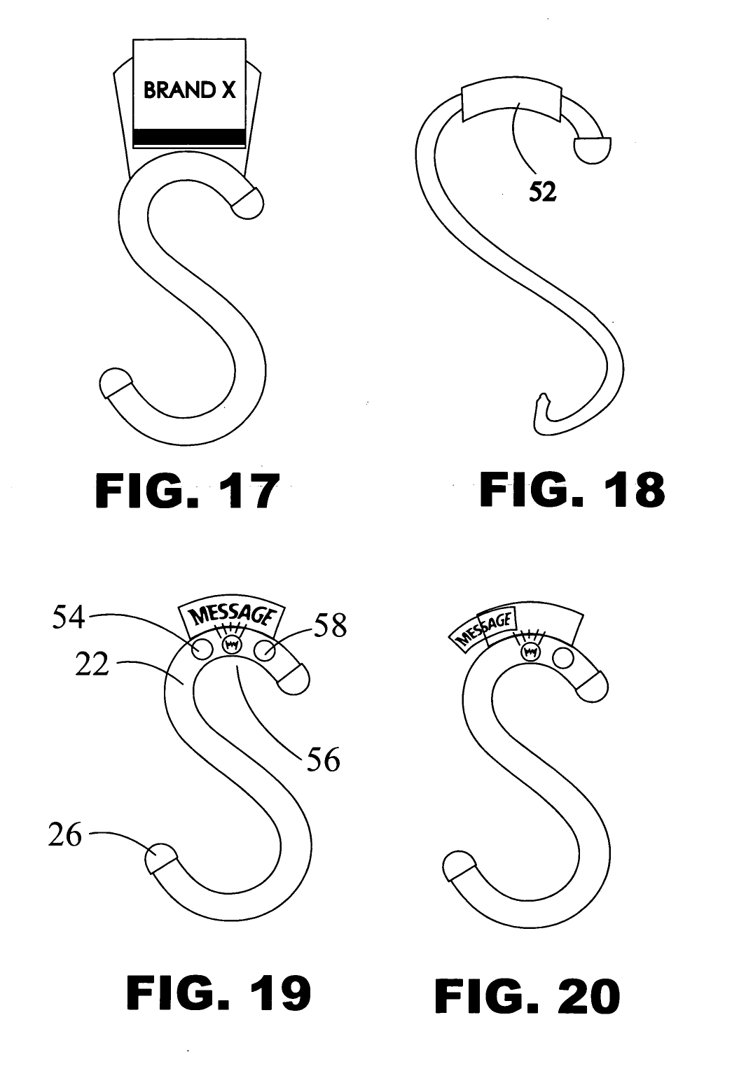

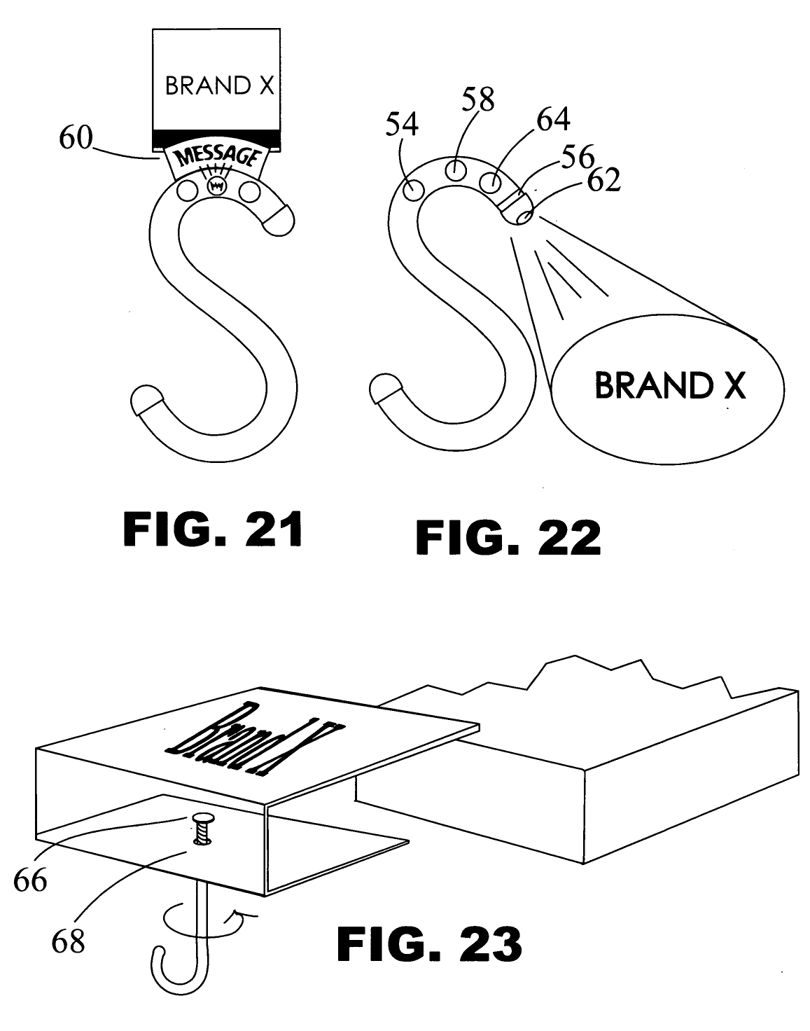

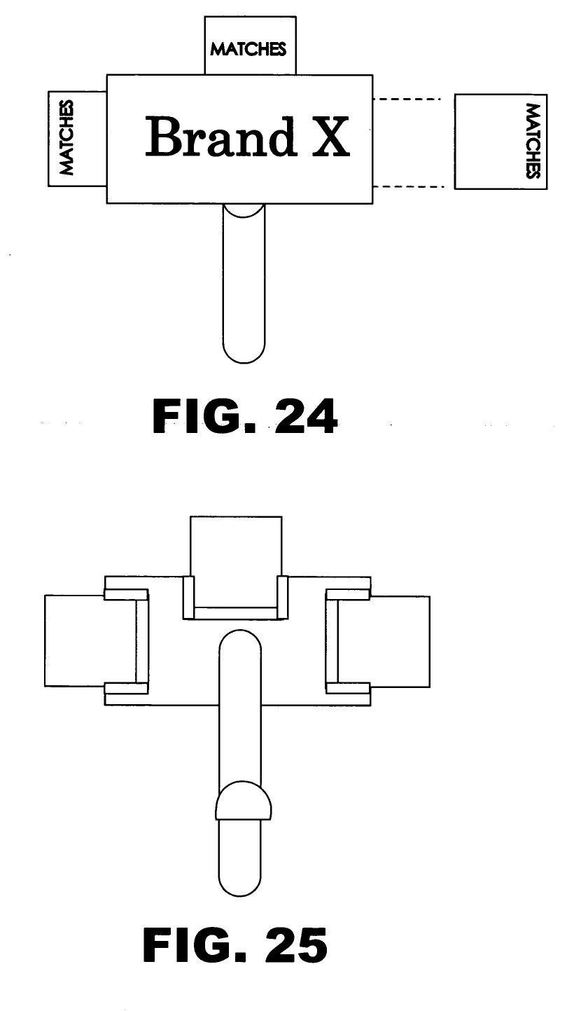

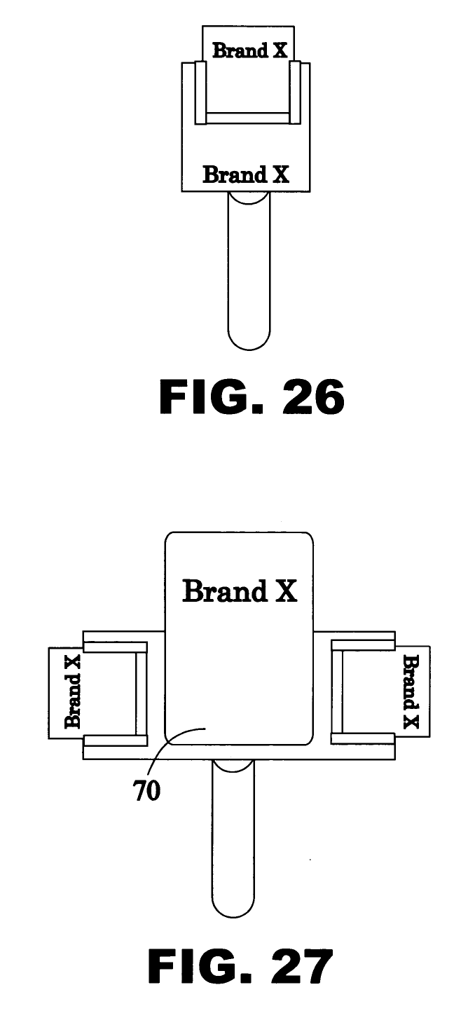

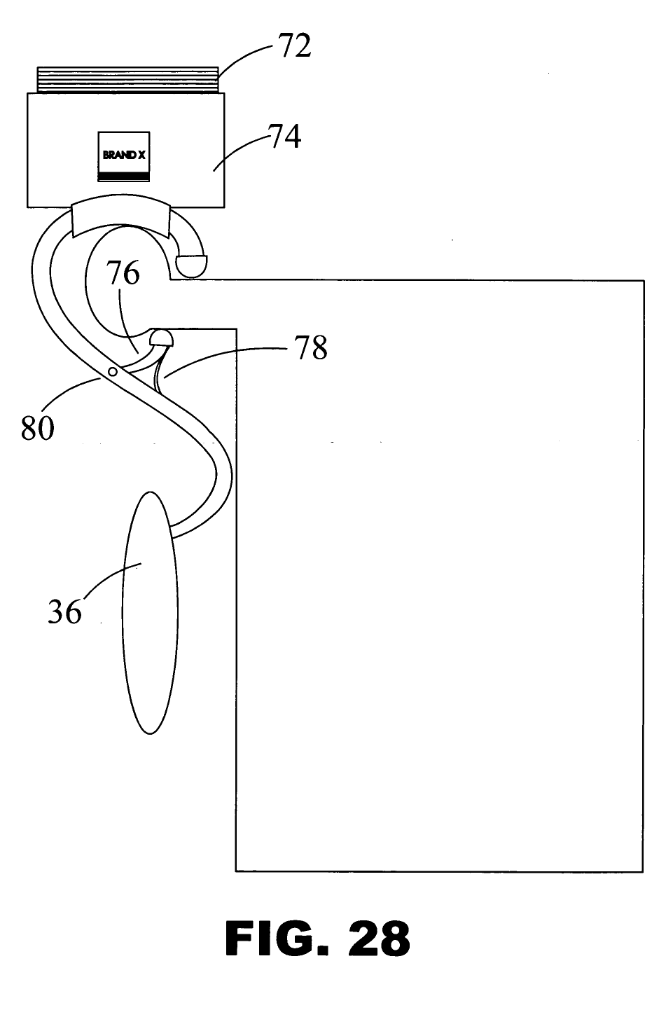

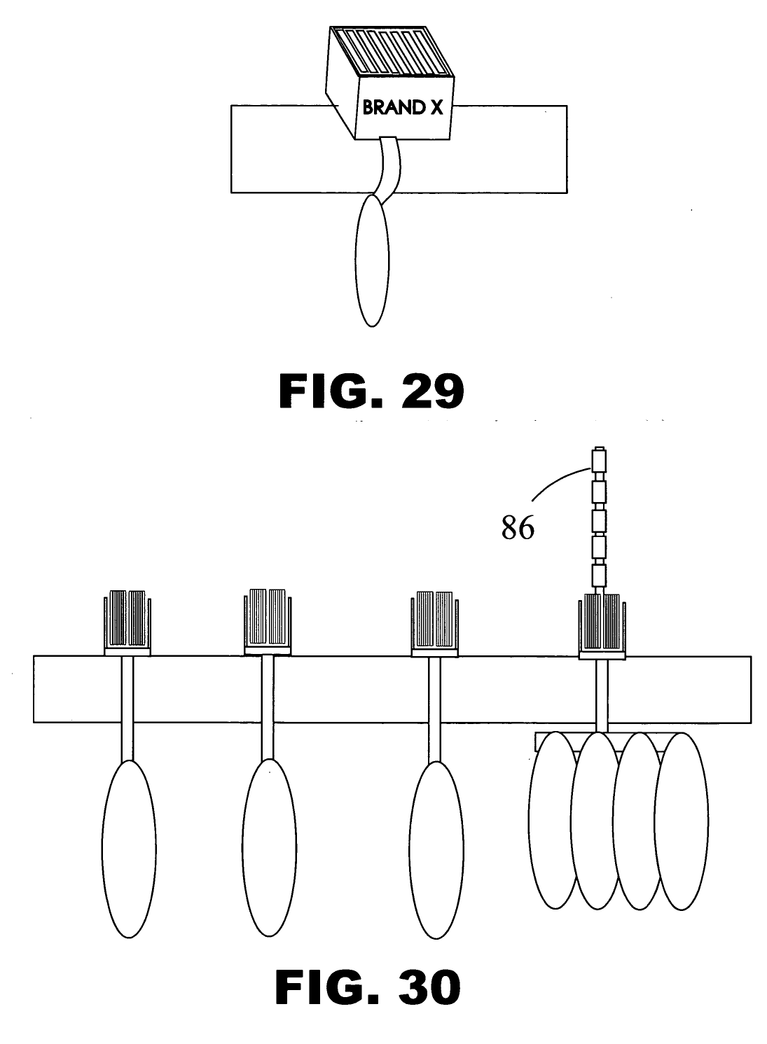

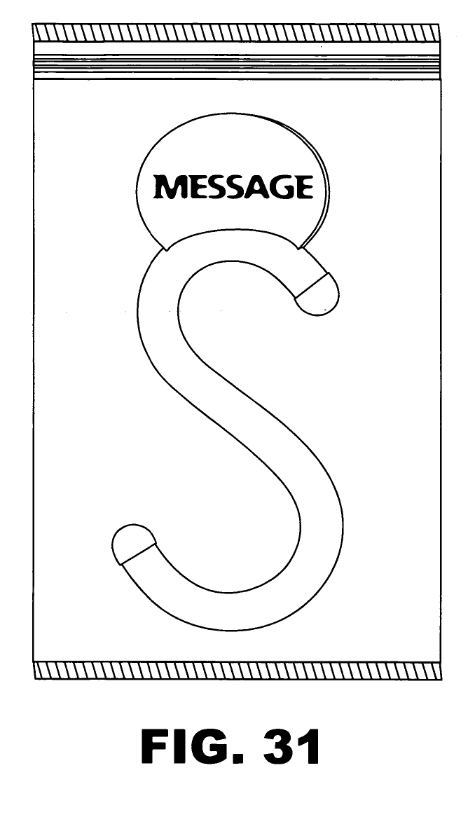

| | |
|---|---|
| 22 | Body |
| 24 | Message Display Area |
| 26a | Hanger Upper Tip |
| 26b | Hanger Lower Tip |
| 28 | Hook Front Top |
| 30 | Hook Back Bottom |
| 32 | Upper Smaller Hook |
| 34 | Askew Message Display |
| 36 | Hanging Item |
| 38 | Secondary Hook |
| 40 | Item Holder |
| 42 | Traditional Match Book |
| 44 | Bar Edge |
| 46 | Table Countertop |
| 48 | Peel-Away Sticky Sheet |
| 50 | Adhesive |
| 52 | Alternative Message Area |
| 54 | Power Source |
| 56 | Light Source Means |
| 58 | Activation Switch |
| 60 | Item Holder |
| 62 | Lens |
| 64 | Projection Image |
| 66 | Screw Mount |
| 68 | Base |
| 70 | Item Package |
| 72 | Postcards |
| 74 | Postcard Holder |
| 76 | Pivoting Arm |
| 78 | Pressure Mechanism |
| 80 | Pivot Pin |
| 82 | Rod-Like Element |
| 84 | Bag Wrapper |

### DESCRIPTION OF THE PREFERRED EMBODIMENT

In the preferred embodiment of this disclosed invention, an “S”-shaped Body 22, relatively thin, hook-like element having Hook Front Top 28 for hanging attachment to Rod-Like Element 82 and/or Bar Edge 44, is injection-molded of plastic. The plastic, known to one skilled in the art, should be inexpensive, yet strong enough so that after its production it can hold at least 6-lbs., the estimated weight of an average coat and pocketbook.

Integrally molded into Hook Front Top 28 is Message Display Area 24 which is suitable for receiving advertising indicia. An advertising message or indicia may be embossed, integrally molded into the plastic of Body 22, or affixed as part of an adhesive label, or connected to Message Display Area 24 through other methods. Message Display Area 24 may be parallel or perpendicular to Body 22, it may be parallel or perpendicular to Table Countertop 44. Since the addition of the weight of Hanging Item 36 can affect the orientation of Message Display Area 24, Askew Message Display Area 34 can be employed to offset the weight shift which would otherwise cause Message Display Area 24 to portray its message in an askew, potentially unappealing manner. A coated or rubberized protective tip Hanger Upper Tip 26a may be adhesively attached to Hook Front Top 28 in order to afford enhanced protection to a support Table Countertop 46. Hanger Lower Tip 26b is constructed in a similar manner to Hanger Upper Tip 26a, thus, it is attached to Hook Back Bottom 30 in order to afford protection from its damaging Hanging Item 36.

The size of either Hook Front Top 28 or Hook Back Bottom 30 may be varied. Upper Smaller Hook 32 discloses a potential disparity in size between Hook Front Top 28 and Hook Back Bottom 30. Moreover, Secondary Hook 38 indicates the potential for the addition of an extra hook or hooks for Hanging Items 36.

Item Holder 40 is manufactured integral to an embodiment of Message Display Area 24 which is flat and perpendicularly covering Body 22 which emanates from underneath Message Display Area 24 and is suitable for holding items such as a Traditional Matchbook 42.

FIG. 15 discloses a series of Peel-Away Sticky Sheets 48 which are typically conceal one-time use Adhesive 50 to hold items such as Traditional Matchbooks 42 until use is desired. An Alternative Message Area 52 is further disclosed.

In an alternate embodiment, Body 22 may contain Power Source 54, which may be a battery, for lighting Light Source Means 56, which may be a form of light bulb, and have Activation Switch 58 for activating Power Source 54 and thereby Light Source Means 56. Message Display Area 24 may have Item Holder 60 for holding an item such as Traditional Match Book 42. Moreover, Body 22 may also contain Lens 62, Power Source 54 and Light Source Means 56 and Projection Image 64, activated by Activation Switch 58 and projected onto Table Countertop 46.

Base 68 is slid under Table Countertop 46. Rotatable Screw Mount 66, in contact with the underside of Table Countertop 46, is then actuated by rotation causing it to pinion itself to Countertop 46. By so doing, the easy separation of Base 68 from Table Countertop 46 is prevented.

Item Package 70 may be a package of cigarettes mounted on an expanded Message Display Area 24. Postcard Holder 74 holds promotional advertising Postcards 72. Pivoting Arm 76 is attached to Body 22 via Pivot Pin 80, which exerts pressure beneath Table Countertop 46 in direct opposition to Hanger Upper Tip 26a as a result of pressure exerted on Pivoting Arm 76 by Pressure Mechanism 78.

An essential oil which mixes virtually entirely throughout the plastic of Body 22 produces scent which can be released over a prolonged time period. Scent may also be added to a coating for the exterior of Body 22.

Regarding packaging, Plastic Body 22 is inserted into Vapor Barrier Plastic Packaging of Bag Wrapper 84, preferably composed of a plastic polymer material such as EVOH™ which is extremely resistant to scent dissipation. The two ends of the bag are then sealed using a conventional heat-sealing machine.

This invention is a novel system. While preferred embodiments of the present invention have been described and illustrated using specific terms, such description is for illustrative purposes only. It may be appreciated and understood that many changes and modification of the invention as described herein may be made by a person skilled in the art to which this subject matter pertains without substantially deviating from the spirit and scope of the invention and of the following claims. As the preferred embodiment is capable of variation, addition, omission and modification without departing from the spirit an scope of the invention, consequently, it is not the intention of the applicant to limit his invention to those modes and embodiments of the invention shown or described above. Protection is desired for all changes and modifications that come within the spirit of the invention.

What is claimed is:

1. A promotional advertising hanger comprising:
at least a first hook element;
at least a second hook element connected with said at least a first hook element;
an area disposed along said connected first and second hook elements suitable for displaying a message.
